(19) United States
(12) Patent Application Publication
(10) Pub. No.: US 2011/0233341 A1
(43) Pub. Date: Sep. 29, 2011

(54) Hybrid emergency ejection system

(76) Inventor: Michael A. Monteforte, Fredericksburg, VA (US)

(21) Appl. No.: 12/802,569

(22) Filed: Jun. 9, 2010

Related U.S. Application Data
(60) Provisional application No. 61/341,025, filed on Mar. 26, 2010.

(51) Int. Cl. B64D 25/12

(52) U.S. Cl. 244/140

(57) ABSTRACT

An emergency escape sequence for a commercial aircraft is shown. Individual pods that are separable from the aircraft are ejected individually, following the separation and ejection of the upper cabin from the fuselage. Parachutes are deployed to assist in the safe descent of the pods. Airbags are also deployed to soften the landing and provide flotation in case of a water landing.

### CROSS-REFERENCE TO RELATED APPLICATIONS

This application is based on U.S Provisional Patent Application Ser. No. 61/341,025 filed Mar. 26, 2010, and claims benefit thereof.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A SEQUENCE LISTING OR A COMPUTER PROGRAM LISTING

Not applicable.

### BACKGROUND OF THE INVENTION

### FIELD OF THE INVENTION

The invention relates to the field of aircraft emergency escape equipment, specifically adapted to commercial passenger aircraft with large numbers of passengers. More specifically it relates to an aircraft comprising a detachable passenger escape pods, which are mounted onto the fuselage of the aircraft via a speedily released set of connectors. The pods are equipped with parachutes and airbags and with autonomous mechanisms ensuring their vertical upward detachment from the remainder of the airplane which is thence left to fall to the ground.

Various arrangements of aircraft emergency equipment have been disclosed in the prior art, that designed to save the lives of passengers and crew in an aircraft which is faced with malfunction, fire or other emergency condition where the airplane is unable to land in a safe fashion.

The combination of parachute/airbag systems deployed for aircraft emergency landing is known. U.S. Pat. No. 5,836,544, U.S. Pat. No. 5,944,282, DE-43 20 470 or DE-195 07 069 are examples of documents of the prior art wherein are presented alternative types of aircraft or helicopters in which an arrangement of suitably deployed parachutes is used in combination with an arrangement of airbags, so as to respectively ensure smooth descending to the ground and damp at the maximum possible extent the substantial forces being developed upon impact to the ground.

Parachute/airbag arrangements have been deployed for emergency landing of selected parts of aircraft equipment, such as the jetisonable aircraft fuel tank means proposed in U.S. Pat. No. 4,306,693.

U.S. Pat. No. 5,356,097, U.S. Pat. No. 5,568,903, FR-855 642 and DE-198 47 546 provide examples in the prior art, wherein is proposed that aircraft may, when emergency conditions arise, be segmented in portions, so as to facilitate safe landing to earth of passengers and/or crew. More particularly, DE-198 47 546 proposes the aircraft to be lengthwise divided in a frontal and a rear portion, wherein under emergency conditions passengers and crew are transferred to the frontal portion which is then laterally cut from the rear portion carrying cargo and fuel. Subsequently the frontal portion is lowered to earth with deployment of a balloon inflated with gas, lighter that the air, on the top thereof, whilst the rear portion falls onto the ground with a pair of parachutes.

Whilst in the above DE-198 47 546 a lateral division of the aircraft is being proposed, U.S. Pat. No. 5,356,097, U.S. Pat. No. 5,568,903 and FR-855 642 propose varying arrangements of longitudinally detachable portions of the aircraft being lowered to the ground with the aid of parachutes.

With the exception of U.S. Pat. No. 5,356,097, they however do not disclose usage of airbag impact absorbing means. In all these documents, the detachable aircraft portions are slidably connected onto suitable rails or track of the fuselage and when detached they carry along the tail portion (empennage tail) of the aircraft as well.

The problem arising with these type of structures is that their detachment from the remainder of the aircraft takes place within a certain period of time necessary for the detachable portion to slide off the fuselage. Even after sliding off, the detached portion may remain for an additional period of time in the vicinity of the remainder of the aircraft, thereby making it possible that an explosion takes place, which is always a possibility under such circumstances. Furthermore the inclusion of the tail portion in the detached portion creates unnecessary excessive load and causes problems in the deployment of parachutes, whereas the exclusion of the cockpit leaves the detachable portion without valuable flight controlling apparatus and instruments.

U.S. Pat. No. 6,695,257 to Lin shows an ejection escape system for passenger airplane. The disclosure of Lin is expressly and fully incorporated herein by reference. The aircraft body includes a left top cabin cover, a right top cabin cover, and a cockpit, with an ejection device on the left top cabin cover and the right top cabin cover to separate the cabin covers from the fuselage. Ejection mechanisms are included to thrust the cabin covers away from the aircraft, to prevent the cabin covers from interfering with passenger ejection and from striking the aircraft, at such points as the tail wings. Following separation of the left and right cabin covers, individual passenger seats are ejected using conventional ejection seats with parachutes.

U.S. Pat. No. 6,682,017 to Giannakopoulos shows a pod which is separable from the aircraft, which holds passengers. The disclosure of Giannakopoulos is expressly and fully incorporated herein by reference. The pod is ejected in an emergency. The pod includes a parachute to slow its decent to the earth, and inflatable air bags under the pod to cushion the landing on the ground and provide flotation if the pod lands on water.

### BRIEF SUMMARY OF THE INVENTION

It is an object of the present invention to overcome the deficiencies in the prior art by proposing an aircraft with a series of detachable passenger escape cabins which extend longitudinally along the fuselage of the aircraft, including the cockpit, but excludes the tail portion and whose detachment takes place in the vertical upward direction, thereby effecting an immediate moving away from the vicinity of the remainder of the aircraft wherein there always exists the risk of crash, fire or explosion.

It is a further object of the present invention to provide an emergency escape system from a commercial aircraft that includes individual escape pods. It should be noted that the invention can be applied to private jets as well. Each pod has its own ejection means, such as conventional rocket motors or explosive devices to propel the pods from the aircraft fuselage. Each pod also has individual parachute means to slow the descent of the pods after ejection, and individual air bags to minimize the shock when the pod collides with the earth. The air bags also provide for flotation should the pod land in water.

The ejection system is normally controlled by the pilot. However, flight sensors could be utilized to operate the system automatically in an emergency, such as when the plane loses power for a certain period of time or an extreme drop in elevation occurs. Of course, the pilot is given a short time to override any automatic deployment of the system.

Each pod according to the invention would hold several passengers. In an emergency the pods are ejected and the passenger is provided with oxygen masks as in normal aircraft, to prevent hypoxia.

### BRIEF DESCRIPTION OF THE SEVERAL VIEWS OF THE DRAWING

FIG. 1 shows a commercial aircraft intended to carry a large number of passengers. Left cabin cover (2) and right cabin cover (3) separate from fuselage (1) in an emergency. It is important that the left and right cabin covers (2) and (3) are propelled from tail wings (4) to prevent collision with the plane, which is usually traveling at a high speed towards the cabin covers.

FIG. 2 shows the cabin covers during separation but before ejection from the aircraft.

FIG. 3 shows the individual pods after ejection, but before parachutes and air bags have been deployed.

FIG. 4(a) shows one pod according to the invention before air bags have been deployed.

FIG. 4(b) shows one pod according to the present invention following deployment of the air bags.

FIG. 4(c) shows one pod according to the present invention following deployment of both the air bag and parachute, after separation and ejection from the aircraft.

### DETAILED DESCRIPTION OF THE INVENTION

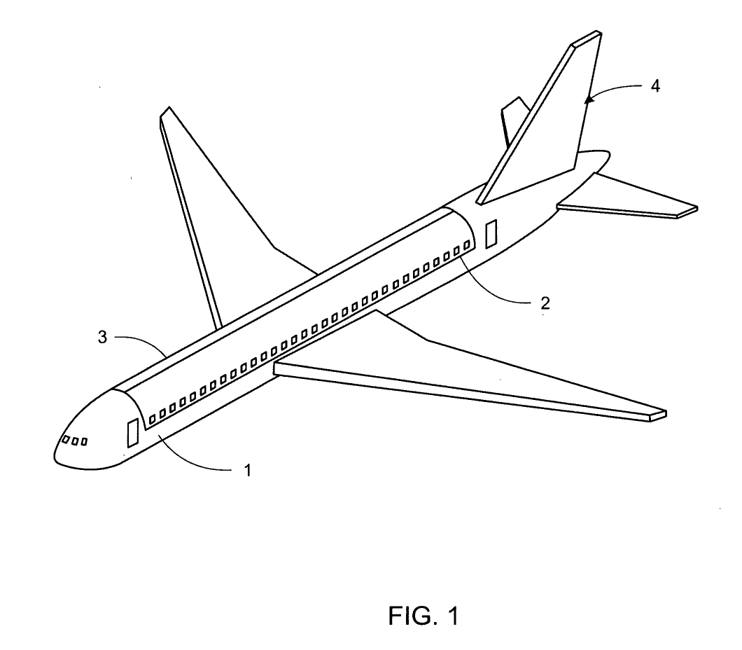

Referring to FIG. 1, a conventional passenger aircraft (1) is provided with a left cabin cover (2) and a right cabin cover (3). In an emergency situation where a normal landing is either impossible or highly dangerous, the cabin covers (2) and (3) are separated from the aircraft and ejected to the left and right of the aircraft (1). This separation is normally accomplished by the installation of detonator cord along the separation points, such as cords of lead azide. The pilot or co-pilot controls ignition of the detonator cord through electrically controlled squids that ignite the cord. Lead azide burns rapidly and at an extremely high temperature, and burns a separation line where it is embedded in or along the aircraft body. Explosive charges are mounted along the sides of the cabin covers (2) and (3) which propel the cabin covers (2) and (3) to the left and right of the fuselage, respectively, to prevent the cabin covers (2) and (3) from striking the pods or tail wings of the aircraft. Alternatively, the left and right cabin covers could be pushed open by the hydraulic, high-pressure system or blown open explosively.

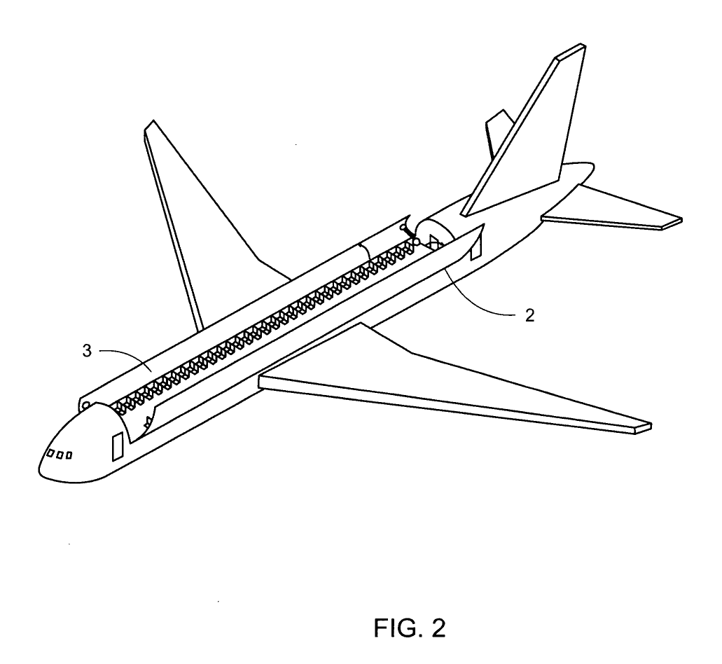

FIG. 2 shows the cabin covers (2) and (3) during separation from the aircraft. The covers have been partly separated, but not ejected away from the aircraft.

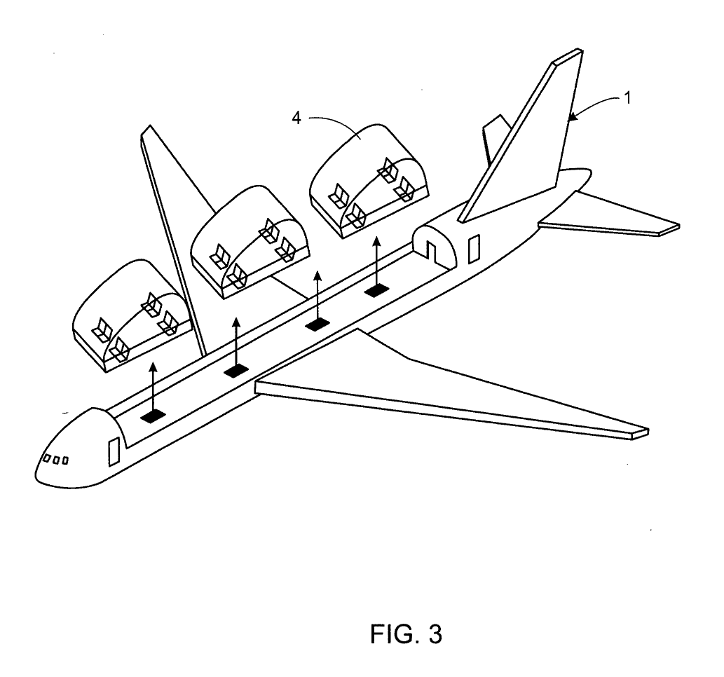

FIG. 3 shows pods being ejected following complete separation of the cabin covers (2) and (3) from the fuselage. Pods (4) have been ejected from the aircraft by explosive or other hydraulic means. The pods are constructed of a durable polymeric material or reinforced fiberglass, or a light metal such as aluminum, or combinations of these materials. No parachutes have been opened, nor have any airbags been deployed. Because each individual pod operates independently of other pods, except for their escape sequence, the failure of one pod would not cause the failure of the entire ejection sequence. Of course, there is a precise sequenced timing involved in the ejection of individual pods. In this manner the pods are separated to prevent individual pods from colliding, or having their parachute cords becoming entangled. Normal explosive devices, as used in military aircraft, are contemplated for the timing of the sequence. High-pressure lines connect each individual pod. A single detonator, or initiator, fills the high-pressure lines with gas. The pilot fires the initiator, which has a normal mechanical firing mechanism, such as a spring loaded firing pin which strikes a primer, as in a gun. The gas mechanically fires all the explosive devices throughout the aircraft, including the detonator cords for cabin cover separation, explosive devices for cabin cover ejection away from the fuselage, and the various explosive devices at each pod. Precision burning in each explosive device times the individual occurrences in their proper sequence. The entire sequencing and ejection system is independent of any electrical system in the aircraft, so it can function even if electrical systems of the airplane are inoperable.

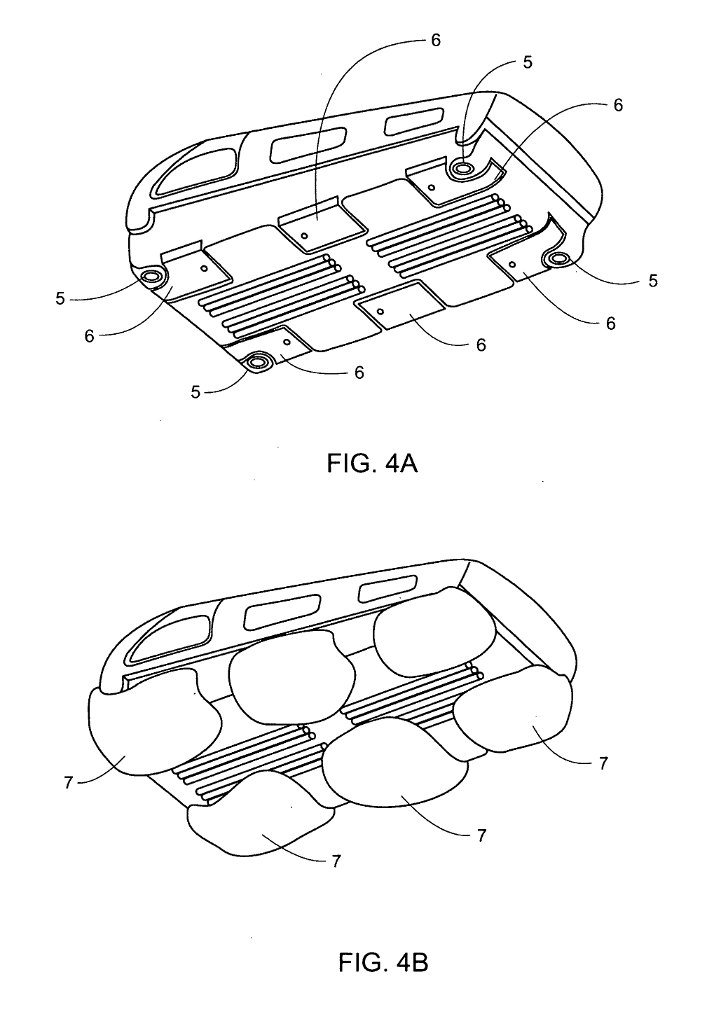

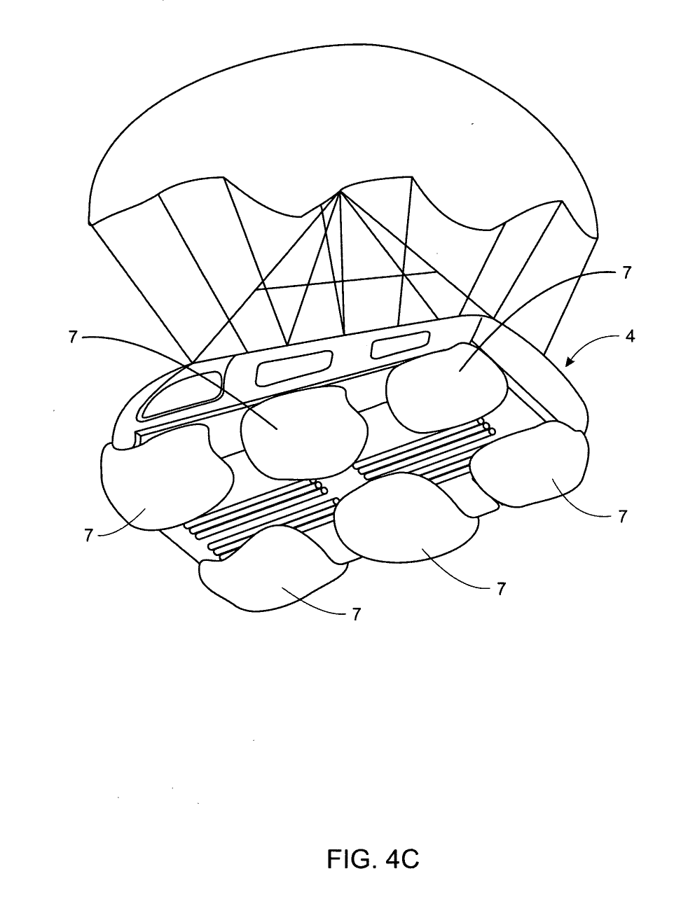

FIG. 4(A) shows an individual pod immediately after separation from the aircraft fuselage. Rocket motors numbered (5) have fired, ejecting the pod from the aircraft. Inflatable bags (7) are located under explosively removable covers (6).

FIG. 4(B) shows an individual pod following explosive removal of the covers (6). Airbags (7) have been inflated with gas from gas generating explosive devices. The purpose of the airbags (7) for flotation should the pod land in water, and to soften impact should the pod land on dry ground.

Pods (4) are ejected with conventional rocket motors located between the aircraft fuselage and the pod. Normally the rocket motors will be secured to the bottom of the pod, to expel hot gas at a right angle to the fuselage. Several rocket motors are located on each pod, such as at the four diametrically opposed corners of the pod, perhaps including others symmetrically spaced in the interior of the bottom surface of the pod. It is important that the rocket motors be symmetrical, to keep the pod from being ejected in eccentric paths from the fuselage. Once the pods are ejected that they come with stabilizers that would keep them from turning upside down. These stabilizers can be just pressurized air on each side of the pod. Each pod is provided with a separate, individual tracking beacon which to assist emergency response teams locate the drop zone. It is also contemplated that each pod will be provided with an automated external defibrillator, to help in the event a passenger has heart issues.

It is important that the pods be secured to the aircraft fuselage by a hydraulic locking mechanism at the bottom of the pod. A hydraulic piston connected to the high pressure hydraulic line will operate the pistons to separate the pods from the fuselage. Alternatively, explosive detonator cords could separate the pods, or explosive bolts as are conventionally used in military aircraft to separate an ejection seat from an aircraft in an emergency.

Explosive devices are then arranged to open parachutes above each pod, in the same conventional fashion as employed in military aircraft. A rocket motor pulls the parachute in a bag like container above the pod. In a few milliseconds another explosive device opens the bag and pulls the parachute above the pod. Then yet another explosive device opens the parachute. Obviously the sequencing is extremely important, so the timing cords in each explosive device must be properly designed.

As seen in FIG. 4(C), explosive devices actuate a parachute sequence. After the parachute is opened, detonator cord opens several covers on the bottom of the pod. Another explosive device fills airbags located in a compartment under the covers on the bottom of the pod. The purpose of the airbag is to soften the shock on landing with the Earth, and to provide flotation if the pod should land on water. FIG. 4(C) shows the pod after ejection, with the parachute and airbags employed.

It is contemplated that individual pods can represent the various classes of passengers, such as first class, business, etc. In that way, the pods could also function to separate the classes of passengers for the convenience of the passengers and flight attendants.

1. In a commercial, passenger aircraft, including a fuselage, the combination of pods, which pods are individually secured to the fuselage in a separable manner, whereby the pods can be separated and ejected from the aircraft, a cabin cover on the left side and the right side of the aircraft, which cabin covers can be separated from the aircraft, and means to eject the individual pods from the aircraft in an appropriate sequence, and parachutes to land the pods safely after ejection, and air bags to be deployed from the bottom of the pod.
